(19) United States
(12) Patent Application Publication
(10) Pub. No.: US 2014/0053113 A1
(43) Pub. Date: Feb. 20, 2014

(54) PROCESSING USER INPUT PERTAINING TO CONTENT MOVEMENT

(71) Applicant: Prss Holding BV, Bussum (NL)

(72) Inventors: Thijs ZOON, Utrecht (NL); Sebastiaen METZ, Meteren (NL)

(73) Assignee: Prss Holding BV, Bussum (NL)

(21) Appl. No.: 13/968,150

(22) Filed: Aug. 15, 2013

Related U.S. Application Data
(60) Provisional application No. 61/683,627, filed on Aug. 15, 2012.

(51) Int. Cl. G06F 3/01

(52) U.S. Cl. CPC G06F 3/017
USPC 715/863

(57) ABSTRACT

A method of processing user input and an apparatus that includes instructions for executing the method are presented. The user input may pertain to a request to move displayed content in a diagonal direction. In accordance with the inventive concept, the user input may be processed simultaneously along the vertical and horizontal directions to move the displayed content as desired. In one aspect, the method may entail determining a content to be moved based on the user input (e.g., a visual object that a user selects), breaking down the user input into an x-direction component and a y-direction component, computing an elasticity factor for at least one of the x-direction component and the y-direction component, and processing the user input by applying the elasticity factor. The elasticity factor cancels out accidental directional deviation in the user input from the main intended direction of displacement.

### CROSS-REFERENCE TO RELATED APPLICATION

This application claims the benefit of U.S. Provisional Application No. 61/683,627 filed on Aug. 15, 2012, the content of which is incorporated herein by reference.

### FIELD OF INVENTION

This disclosure relates generally to a method and apparatus for processing user input, and particularly to a method and apparatus for processing user input to move displayed content in a diagonal direction.

### BACKGROUND

There are numerous devices in the market today that incorporate touchscreens, such as tablets and smart phones. The proliferation of touchscreen devices gave birth to numerous software applications and games that take advantage of the touch sensitivity. Touchscreens are becoming an integral part of many people's lives and, as a result, under pressure to be lighter, smaller, and overall less burdensome to carry around.

While the demand for portability drives touchscreen devices to become more compact, the content that is displayed cannot shrink with the device size because the size of the font or picture that is easily readable to a user remains unchanged. In other words, even on a compact device, a user wants to view the content at the same font size or picture size that he would see on a 24-inch monitor. As a consequence of this limitation, a “page” on a mobile interface is either designed specifically for the portable device-size display (usually with less content per page compared to a page that is designed for a larger display) or designed for a larger display such that a user can only view one section of the content at a time if he were to make the fonts large enough to read on a smaller display. In either case, touchscreen devices receive much directional input from a user to turn the page or move the content around. Many touchscreen devices are responsive to gestures such as sliding, swiping, tapping, and pinching in or pinching out to allow users to conveniently and naturally manipulate the displayed content.

Unfortunately, the touchscreen devices often suffer from a limitation in the user's ability to move the content. Specifically, many conventional touchscreen devices allow the content to be moved only in the x-direction or only in the y-direction at one time. For example, for a user to view content that is to the upper right of the section that is currently displayed, he would have to use two separate gestures, one that moves the currently-displayed content down and another that moves the content left. The user is often forced to get to the content he wants to view by breaking down the gesture into vertical movement and the horizontal movement.

Having to use multiple gestures to achieve what is really a single movement in a diagonal direction is inconvenient and primitive. A method and device that allows a simultaneous x- and y-directional displacement is desired.

### SUMMARY

In one aspect, the inventive concept pertains to a computer-implemented method of processing user input simultaneously along the vertical and the horizontal directions to shift the content that is displayed.

In another aspect, the inventive concept pertains to a computer-implemented method of processing user input. The method entails determining a content to be moved based on the user input, wherein the user input includes a first point P1 and a second point P2, breaking down the user input into an x-direction component and a y-direction component, computing an elasticity factor for at least one of the x-direction component and the y-direction component, and processing the user input by applying the elasticity factor.

In yet another aspect, the inventive concept pertains to a computer-readable set of instructions encoded on a computer-readable storage device, wherein the instructions are operable to cause an operation that includes determining a content to be moved based on the user input, wherein the user input includes a first point P1 and a second point P2, breaking down the user input into an x-direction component and a y-direction component that are perpendicular to each other, computing an elasticity factor for at least one of the x-direction component and the y-direction component, and processing the user input by applying the elasticity factor.

In yet another aspect, the inventive concept pertains to a computer-implemented method of processing a user input, including determining a direction of movement in the user input, and computing a content movement direction based on the user input. The computing causes the content that is displayed to be moved in a direction that is neither the y-direction nor the x-direction.

In yet another aspect, the inventive concept pertains to an apparatus comprising a touchscreen display configured to output visual content and receive a user input, a memory storing computer-readable instructions, and a processor configured to perform an operation based on the computer-readable instructions. The operations include determining a content to be moved based on the user input, breaking down the user input into an x-direction component and a y-direction component, computing an elasticity factor for at least one of the x-direction component and the y-direction component, and modifying the output visual content according to the user input by applying the elasticity factor.

### BRIEF DESCRIPTION OF THE DRAWINGS

FIG. 1 defines the coordinates used in the disclosure.

FIG. 2 depicts an example of a gesture along the x-axis.

FIG. 3 depicts an example of a gesture extending substantially straight in a diagonal direction.

FIG. 4 depicts a flowchart of the gesture-processing method that is triggered by a gesture.

FIG. 5 depicts an example of a gesture that involves a change in the dominant direction.

FIG. 6 is a functional block diagram of a computing device that may be used to implement the disclosed method.

### DETAILED DESCRIPTION

As used herein, a “touchscreen” refers to a visual user input unit that receives input based on movement at the surface, including but not limited to contact with one or more fingertips or a stylus. A “gesture,” as used herein, refers to movement of an input source such as a hand and includes but is not limited to a touch.

Although the inventive concept is described primarily in the context of a touchscreen, the method and apparatus disclosed herein may be applicable to devices that accept user input in ways other than a touch or a gesture, such as via a trackpad, trackball, rocker switch, joystick, etc. Also, while the invention is well-suited for devices such as smartphones, tablets, handheld computers, laptops, and PDAs, one skilled in the art will recognize that the invention can be practiced in many other contexts.

It should also be noted that the inventive concept described herein may be used with various types of programs where user input in the form of touch, gesture, or a pointer action may be detected on separate X and Y axis. The inventive concept may be adapted to work with platform-specific programs, platform-independent programs, object-oriented programs, etc. The inventive concept described herein may be embodied as instructions in a computer-readable medium.

A typical touchscreen device that is available today, such as a tablet or a smartphone, allows a user to scroll the view(s) along two axes—the vertical (y-axis) and horizontal (x-axis). For example, when a user is looking at a page on his touchscreen device, he may scroll up and down or left and right to see more content. A diagonal gesture, however, does not always result in an accurate diagonal movement of the content. Sometimes, a diagonal gesture across the device sometimes does not provide additional content at all. At other times, a diagonal gesture moves the view in either just the vertical direction or just the horizontal direction. At yet other times, the content may move in some diagonal direction that is a little off the intended direction.

The disclosure pertains to a method of processing a diagonal user input. A “diagonal input,” as used herein, is intended to mean any input that includes a request to move the displayed content in a direction that is not substantially horizontal (in the x-direction) or vertical (in the y-direction). By responding to a gesture that is along a direction other than the x-direction or the y-direction, a user has many more degrees of freedom in moving the content that is displayed. The method disclosed herein allows simultaneous control or manipulation of the view along the x-axis and the y-axis with a single gesture. Hence, the user is able to move the view in both the x-direction and the y-direction with one gesture—that is, without losing contact or having some other kind of forced and unnatural element in the input. The simultaneous x- and y-movement applies both to straight-line movements in diagonal directions and to change in the direction of the gesture in the middle of a gesture (e.g., a curve or an angle). The latter applies to a case where a user initially starts moving the view in one direction and, in one continuous move without lifting the finger, changes the direction of the movement.

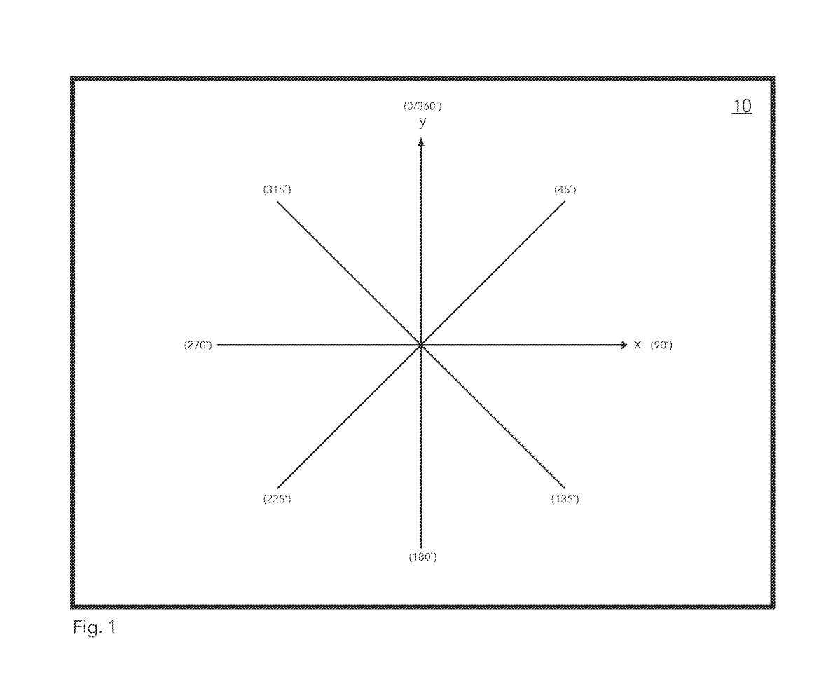

FIG. 1 depicts a content 10 displayed on a touchscreen that is configured to receive gesture-based input from a user. Also shown in FIG. 1 are the coordinates including the x-axis and the y-axis, with the reference angles indicated. The reference angles shown in FIG. 1 are the angles that will be referred to in the description below. As used herein, the x-axis and the y-axis are referred to as the “primary axes” and the axes extending in the 45, 135, 225, and 315-degree angles are referred to as the “secondary axes.”

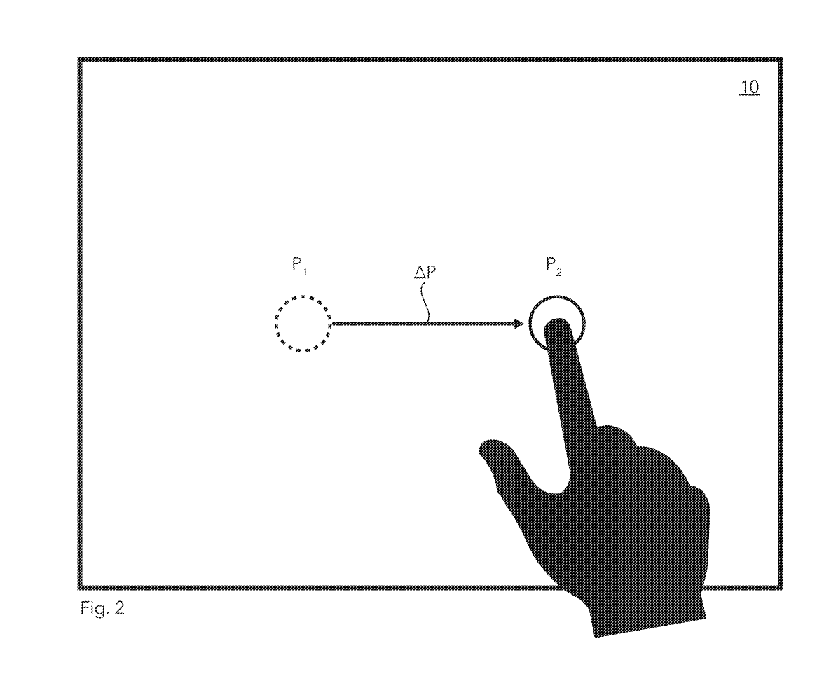

FIG. 2 depicts an example of a gesture along the x-axis (at 90° angle). In the particular example, the user moves his finger from a first point P1 to a second point P2 in a substantially straight line at a 90°-angle. As used herein, the “first point P1” refers to a position on the touchscreen 10 where the gesture was first detected, and the “second point P2” refers to the point at which the gesture is later detected. Upon receiving this input, the device/medium that incorporates the touchscreen 10 detects the gesture, identifies it as being a 90°-angle slide at a given velocity by a given distance, and responds accordingly. The response may include moving the displayed content 10, changing the displayed content to a neighboring picture, or taking some other type of pre-programmed action. Where displayed content is moved, the amount by which the content is moved will be proportional to the distance ΔP between the first point P1 and the second point P2. Sometimes, the speed at which the displayed content is moved is also varied according to the velocity of the gesture.

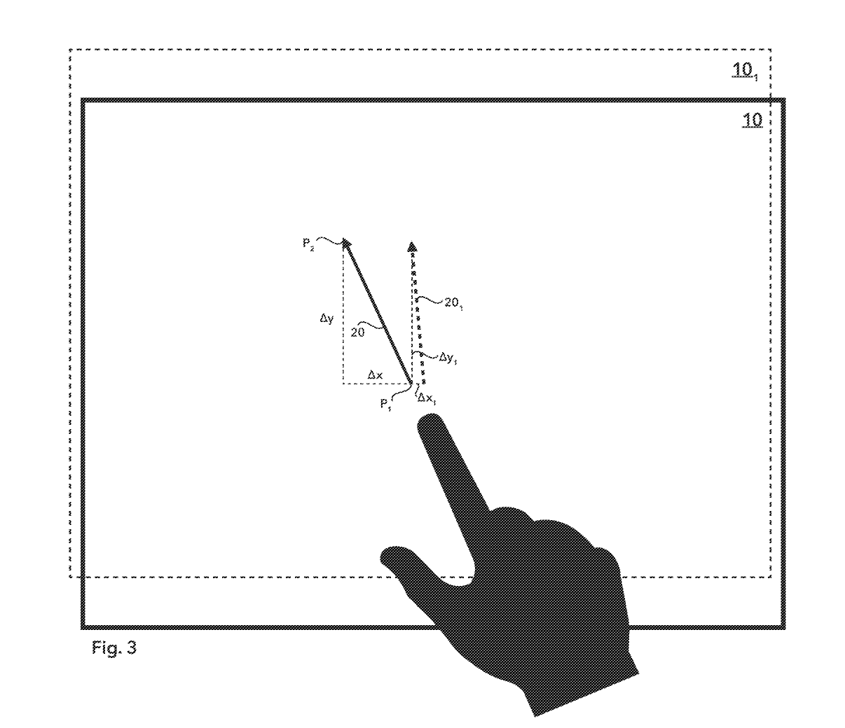

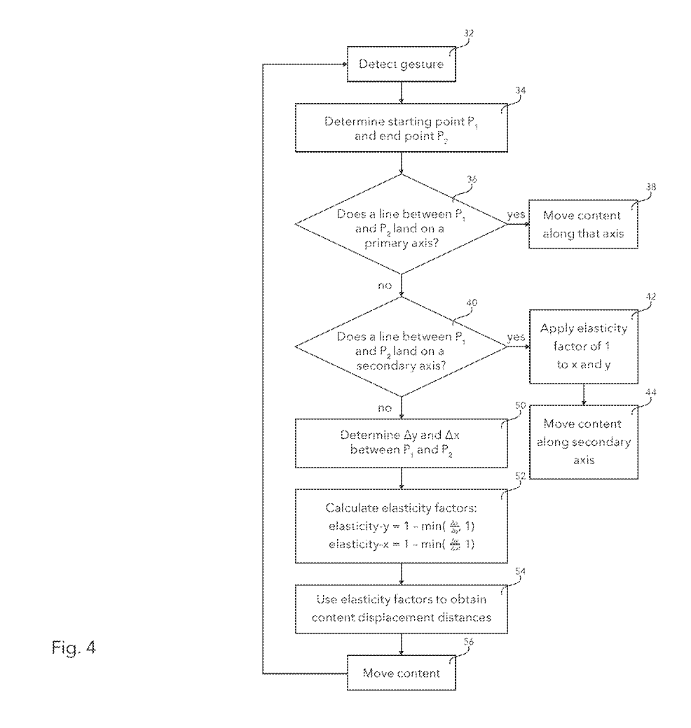

FIG. 3 depicts an example of another gesture, a substantially straight slide along a solid arrow 20. As shown, the solid arrow 20 does not align perfectly with either the x-axis or the y-axis, and is at an angle of about 340°. This off-axis input has an x-direction component and a y-direction component, and triggers a gesture-processing method 30 that is depicted in FIG. 4. As a result of the gesture-processing method 30, the displayed content 10 moves to be displayed content 10₁. After the content displacement, part of the content 10 may no longer be displayed because it moved outside the display area of the hardware display area.

FIG. 4 depicts a flowchart of the gesture-processing method 30 that is triggered by a gesture. Upon detecting a gesture (step 32), the first point P1 and the second point P2 are determined (step 34). A straight line is projected between the starting point P1 and the end point P2. If the line extends substantially along a primary axis (i.e., the x-axis or the y-axis) (step 36), the content displacement in that axis is calculated using a predetermined proportionality and the content is moved accordingly (step 38), as in the case illustrated in FIG. 2. If the gesture is not substantially along a primary axis, it may be checked whether a straight line between P1 and P2 extends substantially along one of the secondary axes (i.e., 45°, 135°, 225°, or 315°) (step 40). If the gesture is substantially along a secondary axis, an elasticity factor of 1 (elasticity=1) is applied to both the x-direction component and the y-direction component (step 42) and the content is moved along the appropriate secondary axis by a distance that is proportional to AP (step 44).

Where the straight line between the starting point P1 and the end point P2 does not align with a primary axis or a secondary axis, the line between the two points P1, P2 is decomposed into an x-direction component Δx and a y-direction component Δy (step 50). Based on the relative magnitudes of Δx and Δy, a dominant direction is determined. The dominant direction is the direction that experiences a greater change. Then, elasticity factor for the directional component other than the dominant component is determined as follows (step 52):

elasticity−y=1−min (Δx/Δy,1)

elasticity−x=1−min (Δy/Δx,1)

At least one of the distance Δx and the distance Δy is then multiplied by its corresponding elasticity factor. Usually, the elasticity factor makes more of a difference for the non-dominant component because the min( . . . ) value comes out to 1 for the dominant component. Using the so-modified distance in the non-dominant direction and the dominant direction, the content-displacement distances, Δx₁ and Δy' are computed (step 54). The content is then shifted by a vector sum of Δx₁ and Δy₁ (step 56) and displayed to the user.

An elasticity factor of 1 indicates that for every 1 unit of gesture distance, the content is shifted by 1 unit of content distance. The relationship between gesture distance and content distance is predefined. An elasticity factor of 0.5 means that for every 1 unit of gesture distance, the content is shifted by 0.5 unit. The elasticity factor allows for freedom of movement on both the x-axis and the y-axis simultaneously, instead of along only one axis at a time. When Δy is changing faster than Δx, meaning the gesture is moving along the y-direction faster than it is moving along the x-direction (i.e., y-direction is dominant), the elasticity factor is applied to Δx to reduce the shifting of the content along the x direction. Conversely, when Δx is changing faster than Δy (i.e., x-direction is dominant), the elasticity factor is applied to Δy to reduce the shifting of the content along the y direction.

Elasticity is applied to the direction other than the direction that registers the most direct change (i.e., the dominant direction). This way, the content movement occurs in the general direction intended by the user. So, in the case of FIG. 3 where change along the y-direction is dominant over change along the x-direction, the elasticity factor is applied to the x-direction to restrict the content movement in the x-direction more than in the y-direction. The content 10 that was displayed, in response to the gesture along the arrow 20, is moved to the new position 10₁ indicated by the broken lines. This usually means that part of the original content 10 is now moved outside the display area and not viewed by the user. The display area can thus accommodate new sections of the content. With elasticity applied to the x-direction, the content is moved along an arrow 20₁ in response to an input gesture along the arrow 20. With application of elasticity, the content displacement may happen in a direction that is modified from the user input.

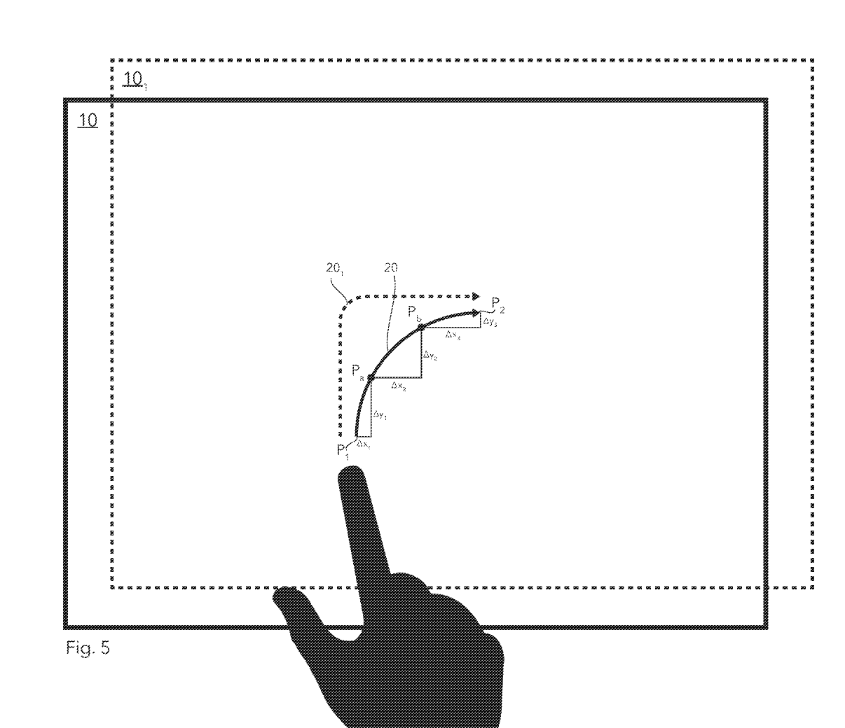

Elasticity is continuously calculated even during one continuous gesture, allowing the user input to be re-evaluated with every directional change. FIG. 5 depicts an example of a gesture that involves a change in the dominant direction. In the first part of the gesture going from P1 to Pa, the dominant direction is the y-direction and Δy1>Δx1. In this part, the elasticity factor is applied mainly to the x-direction, resulting in the content shift happening primarily in the y-direction as shown by the broken line 20₁. During a transitional part of the gesture (going from Pa to Pb) where the movement is in about a 45° direction, the content displacement is approximately in the same 45° direction (Δy2˜Δx2). Then, as the x-direction becomes the dominant direction (Δy3<Δx3), the content displacement happens mainly in the horizontal direction. The Δx and Δy may be determined at a regular time interval. Hence, applying the gesture-processing method 30 of FIG. 4, the positions of P1 and P2 would be readjusted after every time interval At such that at first, P1=P1 and P2=Pa, then P1=Pa and P2=Pb, and finally P1=Pb and P2=P2.

In the example of FIG. 5, let us suppose that Δy1=5, Δx1=1, Δy2=Δx2=3, Δy3=1, and Δx3=5 units. The elasticity factors would be computed as follows:

elasticity−y1=1−min (0.2, 1)=1−0.2=0.8

elasticity−x1=1−min (5,1)=1−1=0

elasticity−y2=1 because the gesture is substantially in a 45° angle

elasticity−x2=1 because the gesture is substantially in a 45° angle

elasticity−y3=1−min (5,1)=1−1=0

elasticity−x3=1−min (0.2,1)=1−0.2=0.8

Between P1 and Pa, the y-direction is dominant and an elasticity factor of 0 is applied to the x-direction. Hence, as shown by the dotted line 20₁, the content displacement corresponding to user input between P1 and Pa is substantially in the y-direction. Between Pa and Pb, the user input direction is along a secondary axis, so the content displacement happens substantially along the corresponding secondary axis. Between Pb and P2, the dominant direction is the x-direction. Hence, the elasticity factor of 0 (as calculated above) is applied to the y-direction, making the content displacement take place substantially in the x-direction as shown by the dotted line 20₁. The content displacement may occur in real time or as the user input is received, as the computation is performed periodically, e.g. at a regular time interval Δt. With the examples of elasticity equations provided above, the content displacement is biased in the dominant direction. In response to the user input, the content 10 may be moved to be content 10₁.

It should be noted that the elasticity factor is not limited to the exact equations provided above, and different embodiments and implementations are contemplated. For example, in some cases, it may be desirable to bias the content displacement in the non-dominant direction or not bias the content displacement in either of the directions. Also, where a bias is applied, the exact way of calculating the elasticity factor may be varied.

The elasticity factor provides a user with a guide that “fixes” accidental directional deviation from the main intended direction of displacement and allows content displacement to happen in the direction that is probably the intended direction.

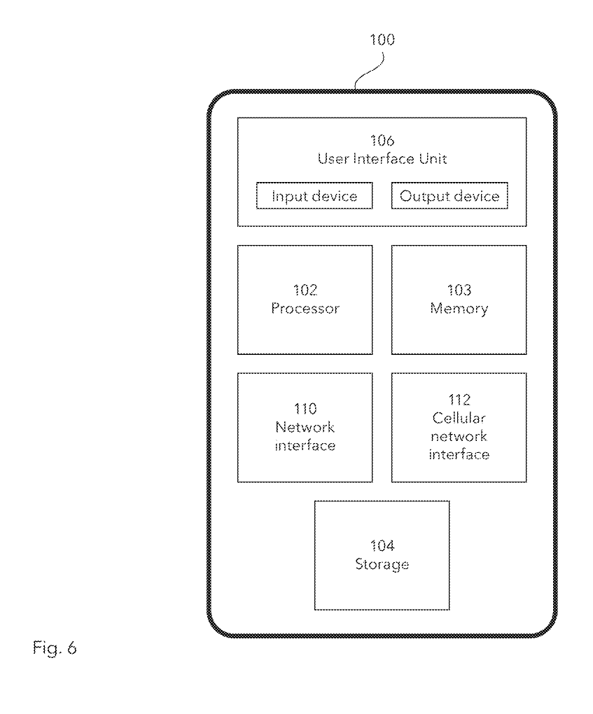

FIG. 6 is a functional block diagram of a computing device 100 that may be used to implement the disclosed method. The computing device 100 has a processor 102, a memory 103, a storage component 104, and a user interface unit 106 that may include a screen or touchscreen for visual display. The processor 102 performs the method disclosed herein and other operations, including running software programs and an operating system, and controlling the operation of various components of the device 100. The memory 103 may be a RAM and/or ROM. The user interface unit 106 includes an input device and an output device. The input device and the output device may be separate components, such as a display monitor in combination with a keyboard and/or trackpad, or an integrated unit like a touchscreen. The storage component 104 may be a hard drive, flash memory, or any other fixed or removable component for data storage. The computing device 100 may be equipped with telephone, email, and text messaging capabilities and may perform functions such as playing music and/or video, surfing the Internet, running various applications, etc. To that end, the device 100 may include components such as a network interface 110 (e.g., Bluetooth and/or wired connectivity to a network such as the Internet), and/or cellular network interface 112. Some of the components may be omitted, and other components may be added as appropriate.

A touchscreen may be implemented using any technology that is capable of detecting contact or gesture. One skilled in the art will recognize that many types of touch-sensitive screens and surfaces exist and are well-known in the art, including but not limited to the following:
capacitive screens/surfaces that detect changes in a capacitance field resulting from user contact;
resistive screens/surfaces where electrically conductive layers are brought into contact as a result of user contact with the screen or surface;
surface acoustic wave screens/surfaces that detect changes in ultrasonic waves resulting from user contact with the screen or surface;
infrared screens/surfaces that detect interruption of a modulated light beam or which detect thermally-induced changes in surface resistance;
strain gauge screens/surfaces in which the screen or surface is spring-mounted, and strain gauges are used to measure deflection occurring as a result of contact;
optimal imaging screens/surfaces that use image sensors to locate contact;
dispersive signal screens/surfaces that detect mechanical energy in the screen or surface that occurs as a result of contact;
acoustic pulse recognition screens/surfaces that turn the mechanical energy of a touch into an electronic signal that is converted to an audio file for analysis to determine position of the contact; and
frustrated total internal reflection screens that detect interruptions in the total internal reflection light path.

Any of the above techniques, or any other known touch detection technique, can be used in connection with the present invention. Furthermore, the invention may be implemented using other gesture recognition technologies that do not necessarily require contact with the device. For example, a gesture may be performed over the surface of a device.

The description is not intended to be exhaustive or to limit the invention to the precise form disclosed. It should be understood that the invention can be practiced with modification and alteration.

What is claimed is:

1. A computer-implemented method of processing user input, comprising:
determining a content to be moved based on the user input, wherein the user input includes a first point P1 and a second point P2;
breaking down the user input into an x-direction component and a y-direction component;
computing an elasticity factor for at least one of the x-direction component and the y-direction component; and
processing the user input by applying the elasticity factor.

2. The computer-implemented method of claim 1 further comprising determining to which directional component the elasticity factor will be applied based on relative magnitudes of the x-direction component and the y-direction component.

3. The computer-implemented method of claim 1, wherein processing the user input pertains to displaying the content differently.

4. The computer-implemented method of claim 1 further comprising applying the elasticity factor to the directional component that represents a direction other than a dominant direction, the dominant direction having the directional component that registers the largest change.

5. The computer-implemented method of claim 1, wherein the elasticity factor for the x-direction component is as follows: elasticityₓ=1−min (Δy/Δx,1), wherein Δy is a change in the y-direction and Δx is a change in the x-direction between the first point P1 and the second point P2.

6. The computer-implemented method of claim 1, wherein the elasticity factor for the y-direction component is as follows: elasticity_{y}=1−min (Δx/Δy,1), wherein Δx is a change in the x-direction and Δy is a change in the y-direction between the first point P1 and the second point P2.

7. The computer-implemented method of claim 1, wherein processing the user input comprises periodically re-computing the elasticity factor.

8. The computer-implemented method of claim 7 further comprising moving the content along a secondary axis when the change in the x-direction is approximately equal to the change in the y-direction, the secondary axis being at an angle of 45° with respect to either the x-direction or the y-direction.

9. The computer-implemented method of claim 1 further comprising computing the elasticity factor periodically to account for a change in the relative magnitudes between the x-direction component and the y-direction component.

10. The computer-implemented method of claim 1, wherein the user input includes a touch.

11. The computer-readable method of claim 1, wherein the processing of the user input comprises continuously changing a displayed portion of the content according to the first point P1 and the second point P2.

12. A computer-readable set of instructions encoded on a computer-readable storage device, operable to cause an operation comprising:
determining a content to be moved based on the user input, wherein the user input includes a first point P1 and a second point P2;
breaking down the user input into an x-direction component and a y-direction component that are perpendicular to each other;
computing an elasticity factor for at least one of the x-direction component and the y-direction component; and
processing the user input by applying the elasticity factor.

13. An apparatus comprising:
a touchscreen display configured to output visual content and receive a user input;
a memory storing computer-readable instructions;
a processor configured to perform an operation based on the computer-readable instructions, wherein the operations include:
determining a content to be moved based on the user input;
breaking down the user input into an x-direction component and a y-direction component;
computing an elasticity factor for at least one of the x-direction component and the y-direction component; and
modifying the output visual content according to the user input by applying the elasticity factor.
